(19) United States
(12) Patent Application Publication
(10) Pub. No.: US 2023/0009268 A1
(43) Pub. Date: Jan. 12, 2023

(54) INTELLIGENT SCHEDULING ASSISTANT

(71) Applicant: Citrix Systems, Inc., Ft. Lauderdale, FL (US)

(72) Inventors: Wenshuang Zhang, Nanjing (CN); Gaojun Chen, Nanjing (CN)

(73) Assignee: Citrix Systems, Inc., Ft. Lauderdale, FL (US)

(21) Appl. No.: 17/387,484

(22) Filed: Jul. 28, 2021

Related U.S. Application Data
(63) Continuation of application No. PCT/CN2021/104914, filed on Jul. 7, 2021.

(51) Int. Cl. G06Q 10/10

(52) U.S. Cl. CPC G06Q 10/1091; G06N 20/00

(57) ABSTRACT

A computer system is provided. The computer system includes a memory and at least one processor coupled to the memory and configured to determine meeting time preference data for one or more invitees to a meeting. The at least one processor is further configured to calculate a plurality of favorability scores wherein each of the favorability scores is associated with one of the invitees and with one of a plurality of proposed time periods for scheduling of the meeting, the calculation based on the meeting time preference data. The at least one processor is further configured to calculate an average of the favorability scores for each of the proposed time periods. The at least one processor is further configured to provide a one of the proposed time periods, that is associated with the highest of the average of the favorability scores, as a recommended meeting schedule time period.

### RELATED APPLICATIONS

This application claims the benefit under 35 U.S.C. § 120 as a continuation of PCT application no. PCT/CN2021/104914 titled INTELLIGENT SCHEDULING ASSISTANT, filed on Jul. 7, 2021, which designates the United States. The content of the aforementioned application is hereby incorporated herein by reference in its entirety.

### BACKGROUND

As “work from home” becomes increasingly popular, online meetings are an important tool to provide collaboration and organization for teams of people working on a project or towards some other common goal. Existing software tools, such as Microsoft® Outlook®, provide mechanisms for organizers to schedule meetings at proposed times for any number of invitees.

### SUMMARY

In at least one example, a computer system is provided. The computer system includes a memory; and at least one processor coupled to the memory and configured to: determine meeting time preference data for one or more invitees to a meeting; calculate a plurality of favorability scores based on the meeting time preference data, each favorability score of the plurality of favorability scores being associated with one invitee of the one or more invitees and with one proposed time period of a plurality of proposed time periods for scheduling of the meeting; calculate a plurality of average favorability scores based on the plurality of favorability scores, each average favorability score being associated with a proposed time period of the plurality of proposed time periods; and provide at least one proposed time period of the plurality of proposed time periods, that is associated with a highest average of the plurality of average favorability scores, as a recommended meeting schedule time period.

At least some examples of the computer system can include one or more of the following features. The at least one processor is further configured to provide the recommended meeting schedule time period to a client device scheduling assistant. The at least one processor is further configured to provide a sorted list of the calculated averages and associated proposed time periods to a client device scheduling assistant. The meeting time preference data comprises unacceptable time periods, acceptable time periods, and preferred time periods. The at least one processor is further configured to calculate each favorability score of the plurality of favorability scores as a weighted sum of a percentage of a first time period of the plurality of proposed time periods that falls within one of the unacceptable time periods, a percentage of a second time period of the plurality of proposed time periods that falls within one of the acceptable time periods, and a percentage of a third time period of the plurality of proposed time periods that falls within one of the preferred time periods. The at least one processor is further configured to determine the meeting time preference data based on responses to queries to the one or more invitees. The at least one processor is further configured to determine the meeting time preference data based on machine learning analysis of historical records of one or more meetings associated with the one or more invitees, the historical records including one or more of meeting invitation times of the one or more meetings, invitation acceptance rates of the one or more meetings, invitation rejection rates of the one or more meetings, join times of the one or more meetings, leave times of the one or more meetings, and active state time periods of the one or more meetings.

In at least one example, a method for scheduling a meeting time is provided. The method includes determining, by a computer system, meeting time preference data for one or more invitees to a meeting; calculating, by the computer system, a plurality of favorability scores based on the meeting time preference data, each favorability score of the plurality of favorability scores being associated with one invitee of the one or more invitees and with one proposed time period of a plurality of proposed time periods for scheduling of the meeting; calculating, by the computer system, a plurality of average favorability scores based on the plurality of favorability scores, each average favorability score being associated with a proposed time period of the plurality of proposed time periods; and providing, by the computer system, at least one proposed time period of the plurality of proposed time periods, that is associated with a highest average of the plurality of average favorability scores, as a recommended meeting schedule time period.

At least some examples of the method can include one or more of the following features. The act of providing the recommended meeting schedule time period to a client device scheduling assistant. The act of providing a sorted list of the calculated averages and associated proposed time periods to a client device scheduling assistant. The meeting time preference data comprises unacceptable time periods, acceptable time periods, and preferred time periods, and the method further includes the act of calculating each favorability score of the plurality of favorability scores as a weighted sum of a percentage of a first time period of the plurality of proposed time periods that falls within one of the unacceptable time periods, a percentage of a second time period of the plurality of proposed time periods that falls within one of the acceptable time periods, and a percentage of a third time period of the plurality of proposed time periods that falls within one of the preferred time periods. The act of determining the meeting time preference data based on responses to queries to the one or more invitees. The act of determining the meeting time preference data based on machine learning analysis of historical records of one or more meetings associated with the one or more invitees, the historical records including one or more of meeting invitation times of the one or more meetings, invitation acceptance rates of the one or more meetings, invitation rejection rates of the one or more meetings, join times of the one or more meetings, leave times of the one or more meetings, and active state time periods of the one or more meetings.

In at least one example, a non-transitory computer readable medium storing executable sequences of instructions to schedule a meeting time, the sequences of instructions comprising instructions to: determine meeting time preference data for one or more invitees to a meeting; calculate a plurality of favorability scores based on the meeting time preference data, each favorability score of the plurality of favorability scores being associated with one invitee of the one or more invitees and with one proposed time period of a plurality of proposed time periods for scheduling of the meeting; calculate a plurality of average favorability scores based on the plurality of favorability scores, each average favorability score being associated with a proposed time period of the plurality of proposed time periods; and provide at least one proposed time period of the plurality of proposed time periods, that is associated with a highest average of the plurality of average favorability scores, as a recommended meeting schedule time period.

At least some examples of the non-transitory computer readable medium can include one or more of the following features. Instructions to provide the recommended meeting schedule time period to a client device scheduling assistant. Instructions to provide a sorted list of the calculated averages and associated proposed time periods to a client device scheduling assistant. The meeting time preference data comprises unacceptable time periods, acceptable time periods, and preferred time periods. Instructions to calculate each favorability score of the plurality of favorability scores as a weighted sum of a percentage of a first time period of the plurality of proposed time periods that falls within one of the unacceptable time periods, a percentage of a second time period of the plurality of proposed time periods that falls within one of the acceptable time periods, and a percentage of a third time period of the plurality of proposed time periods that falls within one of the preferred time periods. Instructions to determine the meeting time preference data based on responses to queries to the one or more invitees. Instructions to determine the meeting time preference data based on machine learning analysis of historical records of one or more meetings associated with the one or more invitees, the historical records including one or more of meeting invitation times of the one or more meetings, invitation acceptance rates of the one or more meetings, invitation rejection rates of the one or more meetings, join times of the one or more meetings, leave times of the one or more meetings, and active state time periods of the one or more meetings.

Still other aspects, examples and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a top-level block diagram of an implementation of an intelligent scheduling system, in accordance with an example of the present disclosure.

FIG. 2 illustrates a schedule timeline, in accordance with an example of the present disclosure.

FIG. 3 is a block diagram of an intelligent scheduling server, in accordance with an example of the present disclosure.

FIG. 4 illustrates an element of an intelligent scheduling assistant user interface display, in accordance with an example of the present disclosure.

FIG. 5 illustrates another element of the intelligent scheduling assistant user interface display, in accordance with an example of the present disclosure.

FIG. 6 illustrates another element of the intelligent scheduling assistant user interface display, in accordance with an example of the present disclosure.

FIG. 7 illustrates another element of the intelligent scheduling assistant user interface display, in accordance with an example of the present disclosure.

FIG. 8 is a flow diagram of a process for intelligent scheduling, in accordance with an example of the present disclosure.

FIG. 9 is a block diagram of a computing platform configured to perform a process for intelligent scheduling, in accordance with an example of the present disclosure.

### DETAILED DESCRIPTION

As noted previously, online meetings are becoming increasingly popular, but it can be difficult to schedule online meetings (or any type of meeting) when there are large numbers of invitees with different time preferences and constraints. This can be particularly problematic when the invitees are in different time zones. As such, it can be difficult for the meeting organizer to select a time period, in which to schedule the meeting, that satisfies all of the invitees. If the organizer schedules the meeting for a time that is inconvenient for a large number of the invitees, then many people may fail to attend, or if they do attend, they may be dissatisfied, and the meeting may be relatively less productive.

To address these and other problems, and as summarized above, various examples described herein are directed to systems and methods for intelligent scheduling of meetings or other events. In some examples, the disclosed techniques are implemented, at least in part, by an intelligent scheduling assistant that executes on a client device, for example as part of a meeting management application, and an intelligent scheduling server that executes on a backend server.

In some examples, the disclosed techniques provide scheduling assistance for a meeting organizer (e.g., one user of the system) by calculating a favorability score for each invitee (e.g., other users of the system) and for each potential or proposed meeting time period. The favorability scores indicate the relative degree of satisfaction or comfort that can be expected for each invitee for each time period. In some examples, the favorability scores are averaged over all (or most) of the invitees for each time period and the results are provided as a sorted list in which the top entries are the recommended times for which the meeting should be scheduled. For example, if time period X to Y is associated with the highest average favorability score over all invitees, then that time period is probably the best time to schedule the meeting.

In some examples, the favorability scores are calculated based on meeting time preference data which may include unacceptable time periods, acceptable time periods, and preferred time periods for each invitee. In some examples, the meeting time preference data may include only unacceptable time periods and acceptable time periods. In some examples, the meeting time preference data may be obtained directly from the invitees, for example based on responses to queries.

In some other examples, the meeting time preference data may be obtained indirectly from historical records that include, for each invitee, previous meeting invitation times and associated acceptance and rejection rates, as well as join times, leave times, and active state times. These factors provide an indication of how well the given meeting invitation time worked for the invitee, at least in the past. In some examples, machine learning techniques may be used to analyze the historical records to more efficiently generate the meeting time preference data.

These systems and methods overcome the problems faced by a meeting organizer when trying to schedule a meeting for a large number of potential invitees that have diverse individual time constraints. Thus, and in accordance with at least some examples disclosed herein, systems and methods are provided for intelligent scheduling. These systems and methods provide an intelligent scheduling assistant on the client device which provides a user interface (UI) that includes scheduling tools, preference data collection, and result presentations, as will be explained in greater detail below. The systems and methods also provide an intelligent scheduling system on a backend server, which communicates with the client based assistant, and which calculates favorability scores for each combination of invitee and potential meeting time, as will also be explained in greater detail below.

As will be understood in view of this disclosure, the systems and methods for intelligent scheduling as provided herein have several advantages over existing methods, which rely on the organizer to choose a meeting time based on limited available information or guesswork and simply hope that enough people will attend. For instance, the systems and methods described herein utilize meeting time preference data for most, or all, of the invitees to calculate a relatively optimal meeting time that will satisfy the largest proportion of the pool of invitees.

Examples of the methods and systems discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements, and features discussed in connection with any one or more examples are not intended to be excluded from a similar role in any other examples.

### Intelligent Scheduling Assistant System

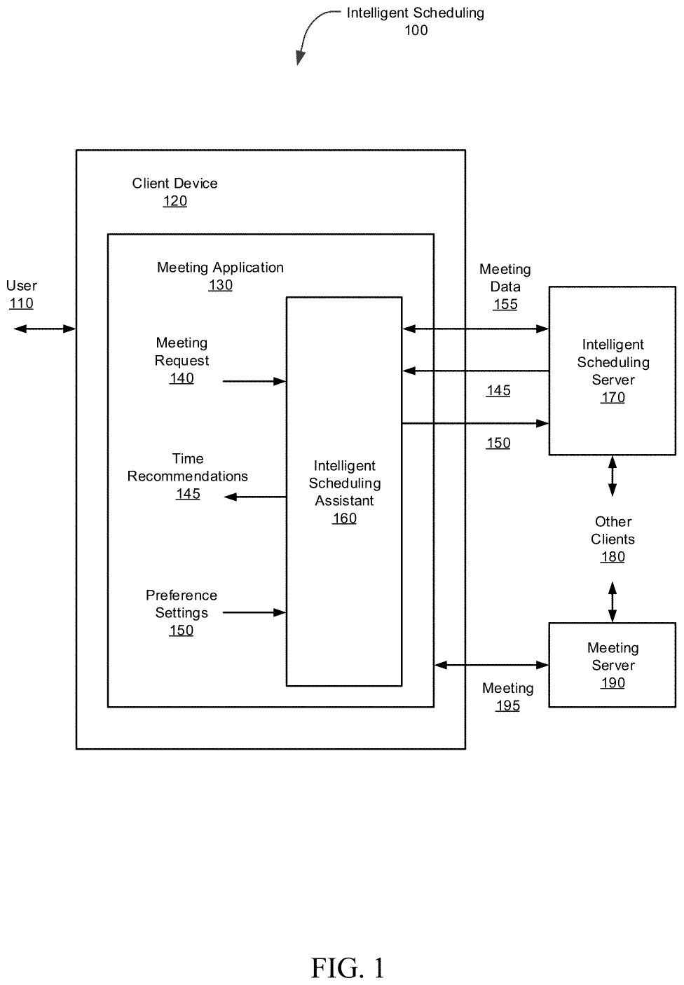

FIG. 1 is a top-level block diagram of an implementation of an intelligent scheduling system 100, in accordance with an example of the present disclosure. As shown in FIG. 1, the system comprises a client device 120 on which a meeting management application 130 executes. In some examples, the meeting management application 130 may be incorporated in an email application such as Microsoft Outlook®, or other similar product. The meeting management application 130 includes an intelligent scheduling assistant 160, which may be installed, for example, as an add-in or plug-in component of the application 130. The system also comprises an intelligent scheduling server 170 and a meeting server 190, both of which may be in communication with other client devices 180 (and associated users).

The intelligent scheduling assistant 160 is configured to interact with users 110 of the system through various UI mechanisms. Users of the system can include both the meeting organizer and the invitees to the meeting. UI controls are provided which allow the organizer to make a meeting request 140 and receive time recommendations 145. Additionally, the user 110 (organizer or invitee) can enter their own preference settings 150. The preference settings 150, along with other meeting data 155, are sent to the intelligent scheduling server 170 to be stored and can be used to generate time recommendation for this or future meeting requests, as will be explained below.

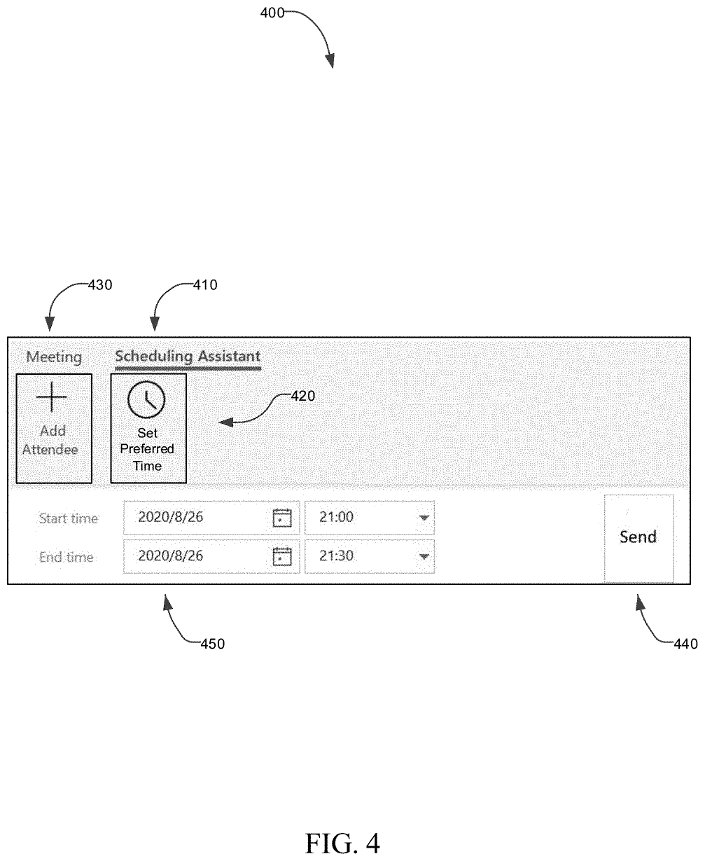

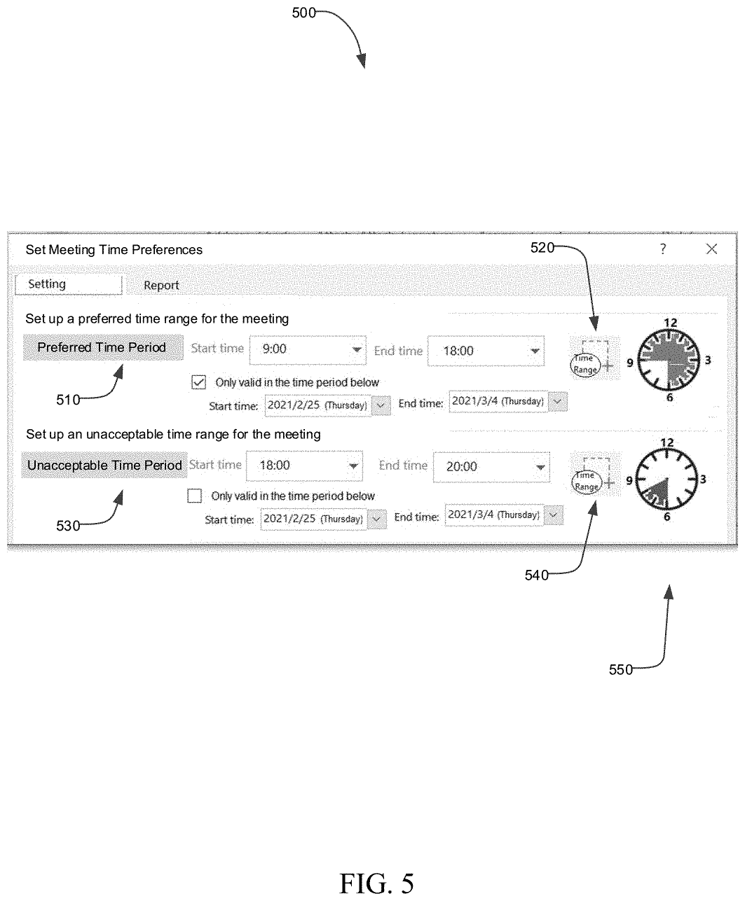

In some examples, the scheduling assistant 160 may be accessed through controls that are located in the ribbon of the meeting management application 130, as shown by scheduling assistant control, reference 410 of FIG. 4. One such control, which is shown in FIG. 4, is a button 420 to set a preferred meeting time for the user of the system. In some examples, control 420 will bring up another UI display, as shown by reference 500 of FIG. 5, into which meeting preference settings 150 (including preferred and unacceptable time periods) may be entered, as will be explained in greater detail below. Additional controls allow for invitees/attendees to be added (e.g., button 430 of FIG. 4) and for the meeting to be requested or scheduled (e.g., send button 440 of FIG. 4). When a meeting is scheduled, that information becomes part of the meeting data 155, along with the list of invitees that accepted and rejected the invitation, for use in future intelligent scheduling recommendations, as will also be explained below.

The operation of intelligent scheduling server 170 will be explained in greater detail below, but at a high-level, the intelligent scheduling server 170 is configured to determine meeting time preference data for the potential attendees of the meeting (e.g., invitees and organizer). The intelligent scheduling server 170 is further configured to calculate favorability scores for each of the attendees for each of a set of potential or proposed time periods for which the meeting might be scheduled. The calculation is based on the meeting time preference data. An average of the favorability scores is then calculated for each of the proposed time periods and the time period associated with the highest favorability score is provided back to the intelligent scheduling assistant 160 of the client device, as a recommended meeting schedule time period 145. In some examples, a sorted list of all the favorability scores and their associated time periods may be provided for the user to review. For example, the user may wish to decide between two time periods that each have relatively high scores, basing the decision on other criteria that are outside the scope of the disclosed techniques.

The meeting server 190 is configured to conduct the meeting 195 at the scheduled time and allow the organizer and the invitees (e.g., on other client devices 180) to interact in an online fashion. In some examples, the meeting server may execute a meeting collaboration tool such as Citrix® GoToMeeting, Microsoft Teams®, Microsoft Skype®, Cisco® WebEx, or Zoom, to name just a few possibilities.

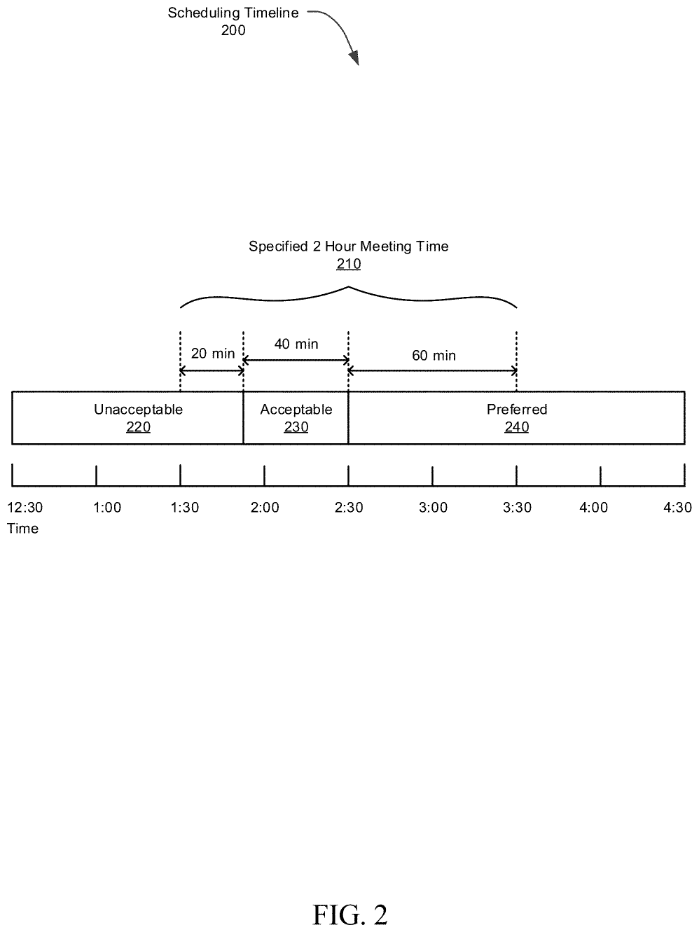

FIG. 2 illustrates a meeting schedule timeline 200 that includes meeting time preference data, in accordance with an example of the present disclosure. The illustrated timeline 200 shows a specified potential two hours meeting time period 210 that extends from 1:30 PM to 3:30 PM. In this example, the meeting time preference data for a user indicates that times earlier than 1:50 PM are unacceptable 220, times between 1:50 PM and 2:30 PM are acceptable 230, and times after 2:30 PM are preferred 240. In general, each user (invitee or organizer) will have their own meeting time preference data which can vary from user to user.

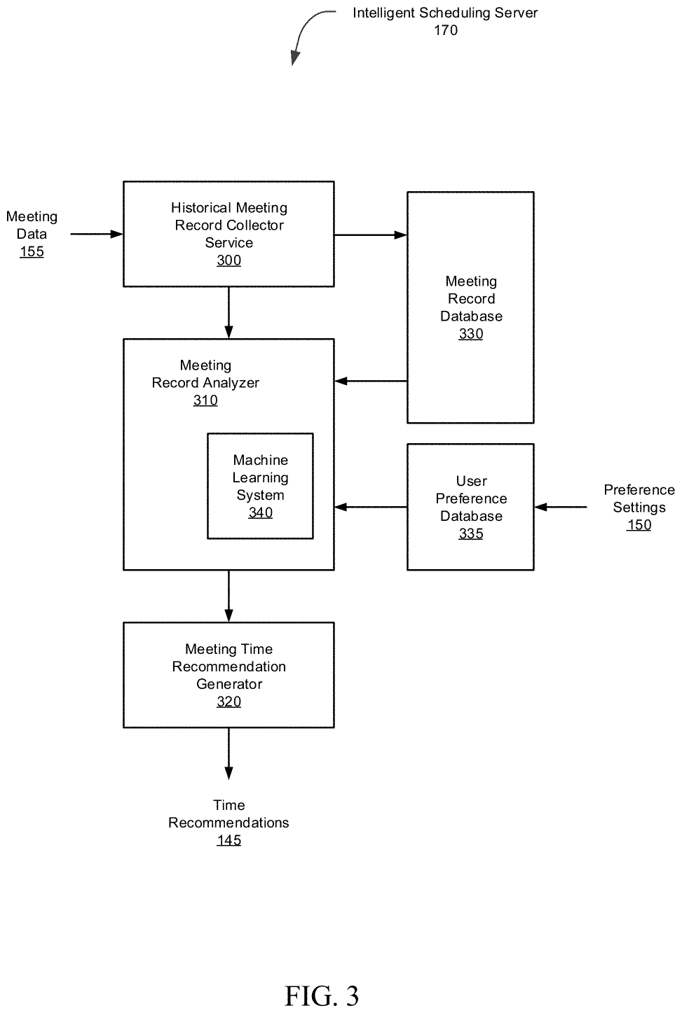

FIG. 3 is a block diagram of an intelligent scheduling server 170, of FIG. 1, in accordance with an example of the present disclosure. The intelligent scheduling server 170 is shown to include an historical meeting record collector service 300, a meeting record analyzer 310, a meeting time recommendation generator 320, a meeting record database 330, and a user preference database 335. In some example, the meeting record analyzer 310 may employ a machine learning system 340.

The historical meeting record collector service 300 is configured to collect meeting data 155, of FIG. 1, and store it in the meeting record database 330. Meeting data can include meeting invitation times. Meeting data can also include, for each invitee, the invitation acceptance rates associated with the invitation times, invitation rejection rates associated with the invitation times, meeting join times, meeting leave times, meeting active state time periods (e.g., the time in which the invitee is actively participating in the meeting), and any other information that may be useful for estimating user preferences for meeting times, as described below.

The user preference database 335 is configured to store user preferences for meeting times that were explicitly obtained from the user (e.g., through the UI 500 of FIG. 5, of intelligent scheduling assistant 160, of FIG. 1), as preference settings 150, of FIG. 1.

The meeting record analyzer 310 is configured to determine meeting time preference data for the invitees to the meeting. In some examples, meeting time preference data includes unacceptable time periods, acceptable time periods, and preferred time periods for each invitee. Meeting time preferences may be obtained by straightforward retrieval from the user preference database 335 if that data has been supplied by the user and is available.

If explicit preference data is not available for a given user, then the meeting time preferences may be estimated from the historical meeting data stored in the meeting record database. For example, if a user often declines meeting invitations scheduled within a given time period, then that time period is likely classified as unacceptable. As another example, if a user often accepts invitations within a given time period, but sometimes joins the meeting late, leaves early, or enters an inactive state during the meeting, then that time period is likely classified as acceptable or unacceptable (depending on the frequency of the behavior), however, that time period is not classified as preferred. As yet another example, if the user often accepts invitations within a given time period and attends the entire meeting in an active state, then that time period is likely classified as preferred.

In some examples, the meeting record analyzer 310 may employ a machine learning system 340 to generate the estimation based on the available data in the historical record for a given user. In some examples, the machine learning system 340 may be a neural net or other suitable artificial intelligence system. The machine learning system may be trained to classify meeting time preferences based on training data that associates meeting time preferences with the user behaviors described above (e.g., acceptance, rejection, etc.). In some examples, training data may be generated by the system based on the meeting preferences that are explicitly provided by the users (e.g., preference settings 150) in combination with historical data that is collected as the system is used over time. For example, the fact that a user claims that a given time period is preferred may be combined with historical data about the user's attendance during that time period to generate a training data point. Many such training data points may be generated in this manner (e.g., for different users and different historical data records) to generate a training data set.

The meeting time recommendation generator 320 is configured to calculate favorability scores for each invitee, for each potential meeting time period, based on the meeting time preference data. In some examples, the favorability score may be calculated as a weighted sum of terms according to the following equation:

Favorability Score=−ρ*(UnacceptableTL/TTL)+μ*(PreferredTL/TTL)+r*(AcceptableTL/TTL)

Where TL is the time length for that term of the equation (i.e., the unacceptable, preferred, and acceptable terms of the equation) and TTL is the total time length for the meeting. So, for example, (Unacceptable TL/TTL) is the percentage of the meeting that falls in the unacceptable time period of the invitee. Referring back to the example shown in FIG. 2, the unacceptable TL equals 20 minutes, the acceptable TL equals 40 minutes, the preferred TL equals 60 minutes, and the TTL equals 120 minutes (2 hours).

Additionally, ρ, μ, and r are the weighting factors for each term which may be determined empirically, based on business or management considerations. For example, assigning higher values to ρ and r, compared to μ, will deemphasize the importance of preferred times relative to acceptable and unacceptable times. In some examples, the weighting factors may be uniquely set for each user or group of users. For example, for some users (such as the president of the company) it may be important to use preferred times rather than merely acceptable times, while for other users, any acceptable time may be sufficient.

An average of the favorability scores (over all users) for each of the proposed time periods is then calculated. Time periods with higher average favorability scores are better than time periods with lower average favorability scores. A recommended meeting schedule time period 145, of FIG. 1, may then be provided as the time period associated with the highest average favorability score.

FIG. 4 illustrates an element 400 of an intelligent scheduling assistant user interface display, in accordance with an example of the present disclosure. The scheduling assistant control 410 is shown in the ribbon of the meeting application 130, of FIG. 1, and in this example includes two controls: button 420 to set the meeting time preferences for the user; and button 430 by which the meeting organizer can add invitees/attendees. In some examples, when an invitee is added, the meeting time preferences for that attendee may be retrieved and displayed for the convenience of the organizer. In such case, the meeting time preferences would be retrieved from the user preference database 335 by the intelligent scheduling server 170, of FIG. 1. Proposed start and stop times (and dates) 450 may be set and the meeting request 140, of FIG. 1, can be made using the send button 440.

FIG. 5 illustrates another element 500 of the intelligent scheduling assistant UI display, in accordance with an example of the present disclosure. In this example, a dialog box is shown for setting the meeting time preferences of the user. The upper portion 510 is used to set the preferred time periods. Start and end times for the preferred time periods may be entered and button 520 can be pressed to enter the specified time range. The lower portion 530 is used to set the unacceptable time periods. Start and end times for the unacceptable time periods may be entered and button 540 can be pressed to enter the specified time range. In some examples, acceptable time periods may be automatically set to include all times periods that fall outside of the range of the unacceptable and preferred time periods, to save the user from having to enter another time range. In some examples, clock-based images 550 may be updated and displayed as a graphical indicator of the specified preferred and unacceptable time ranges.

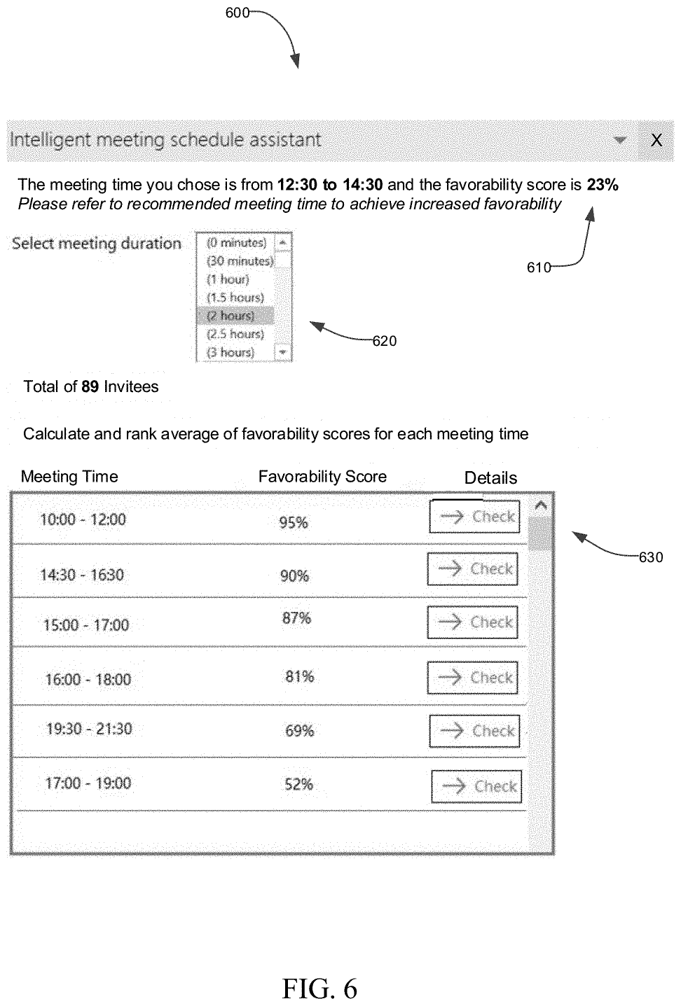

FIG. 6 illustrates another element 600 of the intelligent scheduling assistant UI display, in accordance with an example of the present disclosure. When the organizer requests a meeting at a specified time period (e.g., time and duration), the intelligent scheduling server 170, of FIG. 1, provides recommendation feedback 145, of FIG. 1, as previously described, one example of which is illustrated in this figure. The averaged favorability score 610 for this time period is shown to be 23 percent, a relatively low value and thus a poor choice. The assistant 160, of FIG. 1, provides the organizer with an opportunity to change the duration 620, if desired, and then lists averaged favorability scores 630 for a number of other time periods, allowing the organizer to make a new choice if so desired.

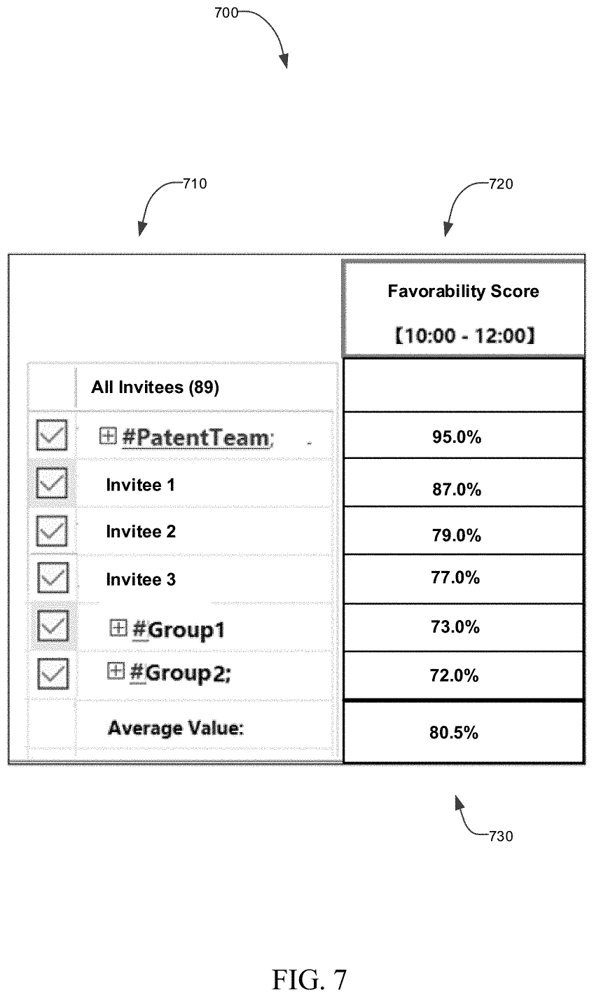

FIG. 7 illustrates another element 700 of the intelligent scheduling assistant UI display, in accordance with an example of the present disclosure. This display provides the organizer with a breakdown of the favorability scores 720 for each invitee 710, for a given time period. The averaged value 730 is also presented.

It will be appreciated that the UI display examples described above are merely representative and that many other examples are possible.

### Intelligent Scheduling Assistant Process

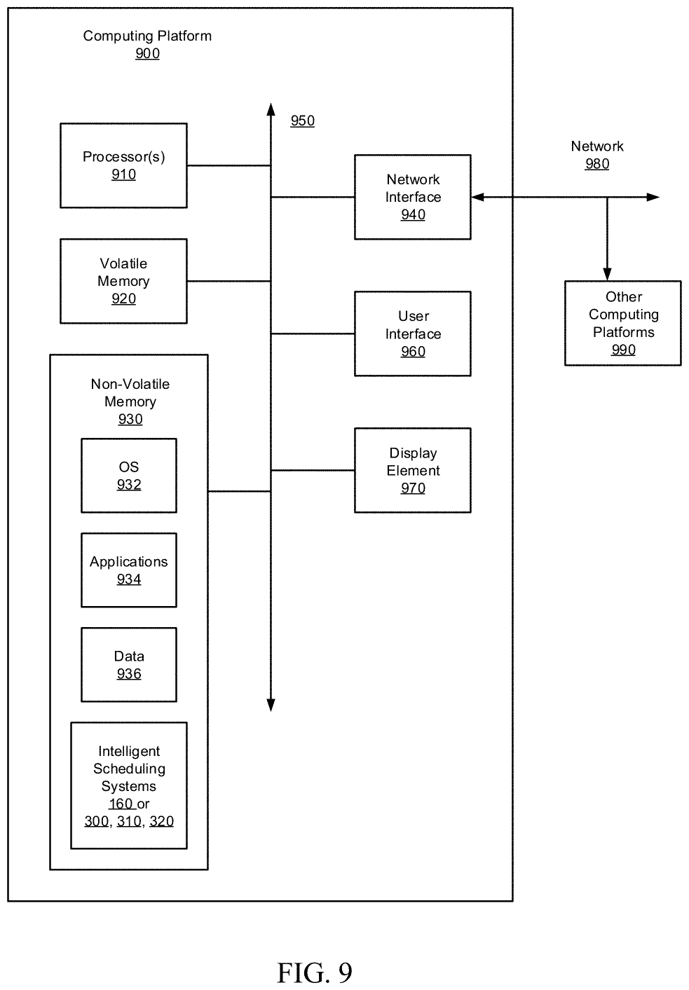

As described above, some examples of the system 100 of FIG. 1, are configured to perform a process for intelligent scheduling of meetings. The processes may be executed on a processor of any suitable type (e.g., processor 910 of FIG. 9).

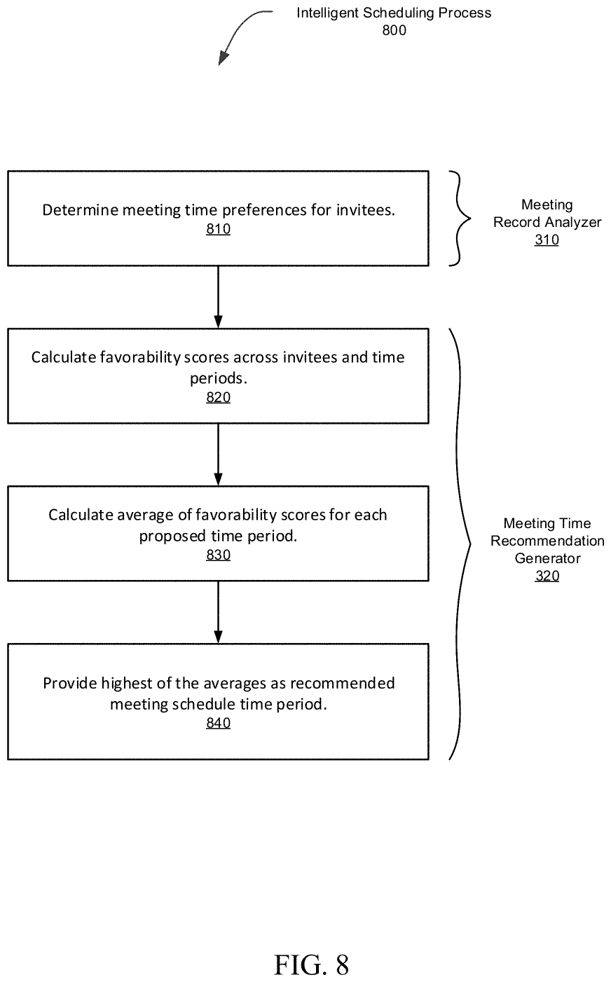

FIG. 8 is a flow diagram of a process 800 for intelligent scheduling of meetings, or the sub-components thereof, in accordance with an example of the present disclosure.

The process 800 starts at operation 810, by determining meeting time preference data for one or more invitees to a meeting. The meeting time preference data comprises unacceptable time periods, acceptable time periods, and preferred time periods. In some cases, the meeting time preference data is determined based on responses to queries to the one or more invitees. In some cases, the meeting time preference data is determined based on machine learning analysis of historical records associated with the one or more invitees. The historical records may include one or more of meeting invitation times, invitation acceptance rates associated with the invitation times, invitation rejection rates associated with the invitation times, meeting join times, meeting leave times, and meeting active state time periods.

Next, at operation 820, favorability scores are calculated for each invitee, for each potential meeting time. Each of the favorability scores is associated with one of the invitees and with one of a plurality of proposed time periods for scheduling of the meeting. The calculation is based on the meeting time preference data for the invitees. In some cases, the favorability score is calculated as a weighted sum of a percentage of the proposed time period that is associated with one of the unacceptable time periods, a percentage of the proposed time period that is associated with one of the acceptable time periods, and a percentage of the proposed time period that is associated with one of the preferred time periods. In some cases, the weight factor for the unacceptable time periods may be a negative number, the weight factor for the acceptable time periods may be a positive number, and the weight factor for the preferred time periods may be a larger positive number.

At operation 830, an average of the favorability scores is calculated for each of the proposed time periods.

At operation 840, the proposed time period that is associated with the highest of the average of the favorability scores is provided as a recommended meeting schedule time period.

In some examples, the recommended meeting schedule time period is provided to the intelligent scheduling assistant component of the meeting application on the client device. In some cases, a sorted list of the calculated averages and associated proposed time periods is provided to the intelligent scheduling assistant.

The processes disclosed herein each depict one particular sequence of acts in a particular example. Some acts are optional and, as such, can be omitted in accord with one or more examples. Additionally, the order of acts can be altered, or other acts can be added, without departing from the scope of the apparatus and methods discussed herein.

### Computing Platform for Providing Intelligent Scheduling Assistance

FIG. 9 is a block diagram of a computing platform 900 configured to perform a process for intelligent scheduling, in accordance with an example of the present disclosure. In some cases, the platform 900 may be a server or workstation configured to host the Intelligent scheduling server 170, of FIG. 1, and the sub-components thereof. In some cases, the platform 900 may be a laptop, workstation, mobile device, or smartphone configured as the client device 120, including the meeting application 130 and intelligent scheduling assistant 160, of FIG. 1.

The computing platform 900 includes one or more processors 910, volatile memory 920 (e.g., random access memory (RAM)), non-volatile memory 930, one or more network or communication interfaces 940, user interface hardware (UI) 960, display element (e.g., screen) 970, and a communications bus 950. The computing platform 900 may also be referred to as a computer or a computer system.

The non-volatile (non-transitory) memory 930 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 960 can include one or more input/output (I/O) devices (e.g., a mouse, a keyboard, a microphone, one or more speakers, one or more biometric scanners, one or more environmental sensors, and one or more accelerometers, etc.).

The display element 970, can provide a graphical user interface (GUI) and in some cases, may be a touchscreen or any other suitable display device.

The non-volatile memory 930 stores an operating system 932, one or more applications 934, data 936, and elements of the intelligent scheduling assistant 160 or the intelligent scheduling server 170, such that, for example, computer instructions of the operating system 932, the applications 934, and the elements of 160 or 170, are executed by processor(s) 910 out of the volatile memory 920. In some examples, the volatile memory 920 can include one or more types of RAM and/or a cache memory that can offer a faster response time than a main memory. Data can be entered through the user interface 960. Various elements of the computer 900 can communicate via the communications bus 950.

The illustrated computing platform 900 is shown merely as an example client device or server and can be implemented by any computing or processing environment with any type of machine or set of machines that can have suitable hardware and/or software capable of operating as described herein.

The processor(s) 910 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 910 can be analog, digital, or mixed. In some examples, the processor 910 can be one or more physical processors, or one or more virtual (e.g., remotely located or cloud) processors. A processor including multiple processor cores and/or multiple processors can provide functionality for parallel, simultaneous execution of instructions or for parallel, simultaneous execution of one instruction on more than one piece of data.

The network interfaces 940 can include one or more interfaces to enable the computing platform 900 to access a computer network 980 such as a Local Area Network (LAN), a Wide Area Network (WAN), a Personal Area Network (PAN), or the Internet through a variety of wired and/or wireless connections, including cellular connections. In some examples, the network 980 may allow for communication with other computing platforms 990, to enable distributed computing.

In described examples, the computing platform 900 can execute an application on behalf of a user of a client device. For example, the computing platform 900 can execute one or more virtual machines managed by a hypervisor. Each virtual machine can provide an execution session within which applications execute on behalf of a user or a client device, such as a hosted desktop session. The computing platform 900 can also execute a terminal services session to provide a hosted desktop environment. The computing platform 900 can provide access to a remote computing environment including one or more applications, one or more desktop applications, and one or more desktop sessions in which one or more applications can execute.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

1. A computer system comprising:
a memory; and
at least one processor coupled to the memory and configured to:
determine meeting time preference data for one or more invitees to a meeting;
calculate a plurality of favorability scores based on the meeting time preference data, each favorability score of the plurality of favorability scores being associated with one invitee of the one or more invitees and with one proposed time period of a plurality of proposed time periods for scheduling of the meeting;
calculate a plurality of average favorability scores based on the plurality of favorability scores, each average favorability score being associated with a proposed time period of the plurality of proposed time periods; and
provide at least one proposed time period of the plurality of proposed time periods, that is associated with a highest average of the plurality of average favorability scores, as a recommended meeting schedule time period.

2. The computer system of claim 1, wherein the at least one processor is further configured to provide the recommended meeting schedule time period to a client device scheduling assistant.

3. The computer system of claim 1, wherein the at least one processor is further configured to provide a sorted list of the calculated averages and associated proposed time periods to a client device scheduling assistant.

4. The computer system of claim 1, wherein the meeting time preference data comprises unacceptable time periods, acceptable time periods, and preferred time periods.

5. The computer system of claim 4, wherein the at least one processor is further configured to calculate each favorability score of the plurality of favorability scores as a weighted sum of a percentage of a first time period of the plurality of proposed time periods that falls within one of the unacceptable time periods, a percentage of a second time period of the plurality of proposed time periods that falls within one of the acceptable time periods, and a percentage of a third time period of the plurality of proposed time periods that falls within one of the preferred time periods.

6. The computer system of claim 1, wherein the at least one processor is further configured to determine the meeting time preference data based on responses to queries to the one or more invitees.

7. The computer system of claim 1, wherein the at least one processor is further configured to determine the meeting time preference data based on machine learning analysis of historical records of one or more meetings associated with the one or more invitees, the historical records including one or more of meeting invitation times of the one or more meetings, invitation acceptance rates of the one or more meetings, invitation rejection rates of the one or more meetings, join times of the one or more meetings, leave times of the one or more meetings, and active state time periods of the one or more meetings.

8. A method for scheduling a meeting time comprising:
determining, by a computer system, meeting time preference data for one or more invitees to a meeting;
calculating, by the computer system, a plurality of favorability scores based on the meeting time preference data, each favorability score of the plurality of favorability scores being associated with one invitee of the one or more invitees and with one proposed time period of a plurality of proposed time periods for scheduling of the meeting;
calculating, by the computer system, a plurality of average favorability scores based on the plurality of favorability scores, each average favorability score being associated with a proposed time period of the plurality of proposed time periods; and
providing, by the computer system, at least one proposed time period of the plurality of proposed time periods, that is associated with a highest average of the plurality of average favorability scores, as a recommended meeting schedule time period.

9. The method of claim 8, further comprising providing the recommended meeting schedule time period to a client device scheduling assistant.

10. The method of claim 8, further comprising providing a sorted list of the calculated averages and associated proposed time periods to a client device scheduling assistant.

11. The method of claim 8, wherein the meeting time preference data comprises unacceptable time periods, acceptable time periods, and preferred time periods, and the method further comprises calculating each favorability score of the plurality of favorability scores as a weighted sum of a percentage of a first time period of the plurality of proposed time periods that falls within one of the unacceptable time periods, a percentage of a second time period of the plurality of proposed time periods that falls within one of the acceptable time periods, and a percentage of a third time period of the plurality of proposed time periods that falls within one of the preferred time periods.

12. The method of claim 8, further comprising determining the meeting time preference data based on responses to queries to the one or more invitees.

13. The method of claim 8, further comprising determining the meeting time preference data based on machine learning analysis of historical records of one or more meetings associated with the one or more invitees, the historical records including one or more of meeting invitation times of the one or more meetings, invitation acceptance rates of the one or more meetings, invitation rejection rates of the one or more meetings, join times of the one or more meetings, leave times of the one or more meetings, and active state time periods of the one or more meetings.

14. A non-transitory computer readable medium storing executable sequences of instructions to schedule a meeting time, the sequences of instructions comprising instructions to:
determine meeting time preference data for one or more invitees to a meeting;
calculate a plurality of favorability scores based on the meeting time preference data, each favorability score of the plurality of favorability scores being associated with one invitee of the one or more invitees and with one proposed time period of a plurality of proposed time periods for scheduling of the meeting;
calculate a plurality of average favorability scores based on the plurality of favorability scores, each average favorability score being associated with a proposed time period of the plurality of proposed time periods; and
provide at least one proposed time period of the plurality of proposed time periods, that is associated with a highest average of the plurality of average favorability scores, as a recommended meeting schedule time period.

15. The computer readable medium of claim 14, wherein the sequences of instructions further include instructions to provide the recommended meeting schedule time period to a client device scheduling assistant.

16. The computer readable medium of claim 14, wherein the sequences of instructions further include instructions to provide a sorted list of the calculated averages and associated proposed time periods to a client device scheduling assistant.

17. The computer readable medium of claim 14, wherein the meeting time preference data comprises unacceptable time periods, acceptable time periods, and preferred time periods.

18. The computer readable medium of claim 17, wherein the sequences of instructions further include instructions to calculate each favorability score of the plurality of favorability scores as a weighted sum of a percentage of a first time period of the plurality of proposed time periods that falls within one of the unacceptable time periods, a percentage of a second time period of the plurality of proposed time periods that falls within one of the acceptable time periods, and a percentage of a third time period of the plurality of proposed time periods that falls within one of the preferred time periods.

19. The computer readable medium of claim 14, wherein the sequences of instructions further include instructions to determine the meeting time preference data based on responses to queries to the one or more invitees.

20. The computer readable medium of claim 14, wherein the sequences of instructions further include instructions to determine the meeting time preference data based on machine learning analysis of historical records of one or more meetings associated with the one or more invitees, the historical records including one or more of meeting invitation times of the one or more meetings, invitation acceptance rates of the one or more meetings, invitation rejection rates of the one or more meetings, join times of the one or more meetings, leave times of the one or more meetings, and active state time periods of the one or more meetings.
